(19) United States
(12) Patent Application Publication
(10) Pub. No.: US 2022/0117833 A1
(43) Pub. Date: Apr. 21, 2022

(54) PORTABLE MASSAGE APPLIANCE

(71) Applicant: Svetozar GRBIC, München (DE)

(72) Inventor: Svetozar GRBIC, München (DE)

(21) Appl. No.: 17/429,127

(22) PCT Filed: Feb. 7, 2020
(86) PCT No.: PCT/EP2020/053224

§ 371 Date: Aug. 6, 2021

(30) Foreign Application Priority Data
Feb. 7, 2019 (DE) 20 2019 100 704.4

(51) Int. Cl. A61H 7/00; A61H 15/00

(52) U.S. Cl. CPC A61H 7/007; A61H 15/0078; A61H 2201/0192; A61H 2205/081; A61H 2201/1207; A61H 2201/0157

(57) ABSTRACT

The invention relates to a portable massage appliance having a shape-modifiable contact segment to be placed onto a body region to be massaged and one or more electrically drivable massage elements that are arranged inside a main part and are designed to cause modification of the shape of the contact segment during operation, a protective segment being arranged between the contact segment and the inner part of the main part.

The invention relates to a portable massage appliance, having a shape-modifiable contact segment for placing onto a body region that is to be massaged, and one or more electrically drivable massage elements, which are arranged inside a main body and are designed to cause a modification of the shape of the contact segment during operation, wherein a protective segment is arranged between the contact segment and the inner part of the main body.

Portable massage appliances are used, for example, for massaging the neck, the shoulders, the shoulder blades, the back, the hips, the legs, the abdomen or the feet, and serve for relaxation and heightening of well-being.

Unlike stationary massage appliances, such as, for example, fixedly installed massage benches or massage chairs, portable massage appliances can be used at different locations or even on the go.

Massage appliances of the type in question have a contact segment for placing onto a body region that is to be massaged, wherein the shape of the contact segment is modified during the operation of one or more massage elements of the massage appliance. By being placed onto the body region that is to be massaged and by the continuous modification of the shape of the contact segment, the contact segment is continuously stressed mechanically because of the resulting friction. The continuous stressing results in increased wear of the contact segment, as a result of which the appearance of the contact segment and the massage effect of the massage appliance are permanently impaired. In addition, the contact segment may become soiled during use. Accordingly, in the case of massage appliances of the type in question, the contact segments can be reversibly released in order to be subsequently replaced or cleaned.

The hygiene requirements existing in the commercial or therapeutic sector can be sufficiently realized only by the use of the portable massage appliance with an exchangeable contact segment since a new or cleaned contact segment can be used for each user. Alternatively, the entire massage appliance would have to be cleaned before use by a new user.

However, it has been demonstrated that, when changing the contact segment, the interior and in particular parts of the massage mechanism are exposed and soiling due to dust, dirt or hairs is possible. Said soiling is problematic not only from a technical aspect, since dirt, dust and hairs may impair the operation of the massage mechanism. Said soiling is also problematic for hygiene reasons.

It has also been shown that the shape-modifiable main body may become distorted and then the shape-modifiable contact segment (14) can no longer be attached or removed without having to bring the shape-modifiable main body into shape in a complicated manner. In embodiments not according to the invention and not having a protective segment, this can lead in the worst case to the housing which contains the drivable massage mechanism rotating in the main body since the main body is not sufficiently stable in terms of shape.

The object on which the invention is based thus consists in providing a massage appliance in which the soiling of the main body interior can be prevented or at least reduced, and therefore the contact segment can be changed under sufficiently hygienic conditions. In addition, the stability of the main body is intended to be increased.

The object is achieved with a massage appliance of the type mentioned at the beginning, wherein a protective segment through which the massage elements extend is arranged between the contact segment and the housing.

It has surprisingly been shown that the protective segment enables the entire integrity and shape of the shape-modifiable main body to be maintained even when the shape-modifiable contact segment is removed. However, also with the contact segment attached, the protective segment results in greater stability of the entire massage appliance.

It has also been surprisingly shown that the soiling of the main body interior can be prevented not only when the contact segment is changed. Soiling of the main body interior can namely also take place when the contact segment is attached. Depending on the manner of fastening the contact segment to the main body, openings can also be formed between contact segment and main body. These openings may be, for example, intermediate spaces between two press studs or two zip fasteners. The protective segment enables contamination of the main body interior through said openings to be prevented or at least reduced.

In addition, it has been surprisingly shown that the protective segment also enables the sensation for the user to be improved. In particular in the case of massage appliances which have openings between contact segment and main body, the sensation on the skin can be improved for the user if a protective segment is present and said openings are closed by said protective segment.

In a particularly preferred embodiment, the protective segment is composed of a textile fabric, the textile fabric preferably being a net material. The textile fabric can have natural fibers and/or synthetic fibers. Furthermore, the textile fabric in some parts or completely can be formed as a woven fabric, a formed-loop knitted fabric, a drawn-loop knitted fabric, a braid or as a nonwoven material or felt. In this connection, it is preferred that the protective segment has an opening for each massage element extending through it. The size of the opening here is preferably selected in such a manner that the massage element (together with the massage head) pass through the opening and operation of the massage appliance is also possible without the massage elements touching the side edges of the opening. On the other side, the opening is as small as possible in order to ensure as great a protection as possible against soiling. The number of openings is preferably identical to the number of massage elements.

The protective segment is preferably irreversibly connected to the shape-modifiable main body. According to the invention, the irreversible connection is undertaken preferably by stitching the protective segment to the main body.

It is preferred according to the invention if the shape-modifiable main body (11) is at least partially formed from a textile, leather and/or synthetic leather. In particular, it is preferred if the main body is at least partially or completely formed from synthetic leather. Synthetic leather has the advantage of being hard-wearing and washable in comparison with leather, and it is also, however, preferred for cost reasons and for ecological reasons.

In one embodiment of the massage appliance according to the invention, the contact segment is connected to the main body by means of one or more zip fasteners. Zip fasteners provide a mechanically loadable and at the same time flexible connection which is releasable in a non-destructive and reversible manner and which, owing to the simple and rapid actuation capability, is particularly suitable for exchangeable segments. Furthermore, zip fasteners can be produced cost-effectively and/or can be additionally purchased and available in various designs and large piece numbers. The respective slider grips of the zip fastener slides are preferably arranged in such a manner that they are concealed by the contact segment or the main body, and therefore the use comfort of the massage appliance is not impaired Alternatively, the one or more zip fasteners are designed without a slider grip.

The massage appliance according to the invention is advantageously developed in that one or more rows of teeth run along the side edges of the contact segment.

Owing to the fact that one or more rows of teeth run along the side edges of the contact segment, it is avoided that the one or more zip fasteners are arranged in the contact region of the contact segment, which comes into contact with the body region that is to be massaged, and therefore an impairment of the use comfort of the massage appliance by the one or the more zip fasteners is avoided. In addition, the arrangement of one or more rows of teeth along the side edges of the contact segment results in a mechanically robust connection between the main body and the contact segment, and therefore the service life of the massage appliance is increased.

In another preferred embodiment of the massage appliance according to the invention, a first row of teeth runs along a first side edge of the contact segment and a second row of teeth runs along a second side edge of the contact segment, the first side edge of the contact segment being arranged substantially opposite the second side edge of the contact segment. The zip fastener of the first row of teeth and the zip fastener of the second row of teeth preferably have opposite opening directions. It is thus avoided that, by pulling on the contact segment, the corresponding zip fasteners can be opened, and therefore the contact segment is released from the main body. The risk of an unintentional release of the contact segment from the main body is thereby considerably reduced.

In a further embodiment of the massage appliance according to the invention, the contact segment is connected to the main body by means of one or more hook-and-loop fasteners. In addition to the one or more hook-and-loop fasteners, the contact segment can also be connected to the main body by one or more zip fasteners. Hook-and-loop fasteners can be opened particularly rapidly and, moreover, are extremely cost-effective. The release of the contact segment from the main body and therefore also the exchange of a worn contact segment for a new contact segment are therefore accelerated, as a result of which the use comfort is further increased.

Furthermore, a massage appliance according to the invention is preferred, in which the contact segment is connected to the main body by means of one or more press studs. In addition to the one or more press studs, the contact segment can also be connected to the main body by one or more zip fasteners and/or by one or more hook-and-loop fasteners. Press studs are particularly loadable and have a long service life. In particular in the case of contact segments composed of durable and resistant materials and a resulting comparatively long service life, the use of press studs is advantageous.

In another embodiment of the massage device according to the invention, the contact segment has a contact region, which is designed to touch the body that is to be massaged. The contact region of the contact segment is formed at least partially from a textile fabric. The textile fabric is preferably machine-washable, and therefore the cleaning of the contact segment is simplified. The textile fabric can have natural fibers and/or synthetic fibers. Furthermore, the textile fabric can be formed in some parts of completely as a woven fabric, a formed-loop knitted fabric, a drawn-loop knitted fabric, a braid or as a nonwoven material or felt. In particular, the surface of the textile fabric is not very rough, and therefore the user experiences a pleasant touch and the friction effect caused by the modification of the shape of the contact segment is minimized.

In a particularly preferred embodiment of the massage appliance according to the invention, the textile fabric is formed as a net material. The net material is preferably permeable to air and/or moisture. The air permeability ensures sufficient ventilation of the body region that is to be massaged, and therefore the massage comfort is increased. The moisture permeability additionally enables moisture, for example body sweat, to be transported away from the body region that is to be massaged, as a result of which the massage appliance is usable even over a prolonged period of time and at higher temperatures.

In addition, the massage appliance according to the invention is advantageously developed in that the contact segment is padded at least in some parts. The padding is formed here in such a manner that the one or more massage elements furthermore cause a modification of the shape of the contact segment during operation, which can be perceived by the person being massaged. The padding damps the effect of the movement of the one or more massage elements, as a result of which the massage comfort is increased. In addition, elastically deformable or flexible massage attachments can be dispensed with, and therefore the production costs of the massage appliance are reduced.

In another embodiment of the massage appliance according to the invention, the main body has two elongate side parts, which each extend laterally from the contact segment. The two elongate side parts serve, for example, for stabilizing the massage appliance during the massage. In order to hold the massage appliance in the desired position, the two elongate side parts can be gripped, for example, by the user. When the massage appliance is used for carrying out a neck massage, the two elongate side parts are each placed over a shoulder of the user such that the ends of the two elongate side parts can be gripped approximately in the user's chest region. Alternatively, one of the two elongate side parts or both elongate side parts can also run laterally past the body in the lower upper body region such that the ends of the two elongate side parts can be gripped approximately in the abdomen or hip region of the user. The massage appliance can thereby be held pleasantly by the user when different back massages are carried out.

In addition, a massage appliance according to the invention is preferred in which the elongate side parts of the main body each have a loop. The loops can be gripped particularly comfortably and pleasantly by the user and thus permit the massage appliance to be held for a prolonged period of time. In addition, the contact pressure of the contact segment on the body region that is to be massaged can be varied in a particularly simple manner by the user by subjecting the loops to a tensile force, as a result of which the massage intensity can ultimately be adapted.

In a further embodiment of the massage appliance according to the invention, the one or more electrically drivable massage elements comprise one or more massage heads. The one or more massage heads can be designed, for example, to perform rotational, pummeling and/or linear movements. In particular, the one or more electrically drivable massage elements are connected to a control device by means of which the drive of the one or more massage elements can be controlled. The control device is preferably designed to control the movement speed and/or the movement direction of the one or more massage elements.

In addition, the massage appliance according to the invention is advantageously developed in that the one or more electrically drivable massage elements are designed to perform a kneading massage. In the case of a kneading massage, the one or more electrically drivable massage elements move in all three directions in space. The kneading massage brings about a strengthening of the muscles. At the same time, the blood circulation and/or the metabolism can be stimulated. The kneading massage is also particularly preferred for releasing tension in the back and for preventing back problems.

In an advantageous development, the massage appliance according to the invention comprises one or more heating elements, which are arranged inside the main body and are designed to cause heating of the contact segment during operation. By means of the heating of the contact segment, the body region that is to be massaged is heated, and therefore the massage comfort is further increased. In addition, by means of the one or more heating elements, the massage appliance can be additionally used for heat therapy. The one or more heating elements are preferably connected to the control device, the control device being designed to control the temperature of the one or more heating elements.

The object on which the invention is based is furthermore achieved by a contact segment for a portable massage appliance according to one of the previously described embodiments. The contact segment according to the invention serves, for example, for the exchange of worn contact segments. By exchanging the contact segment of a massage appliance, the action and the appearance can be maintained even in the event of intensive use for a long period of time.

Preferred embodiments of the invention will be explained and described in more detail with reference to the attached drawings, in which:

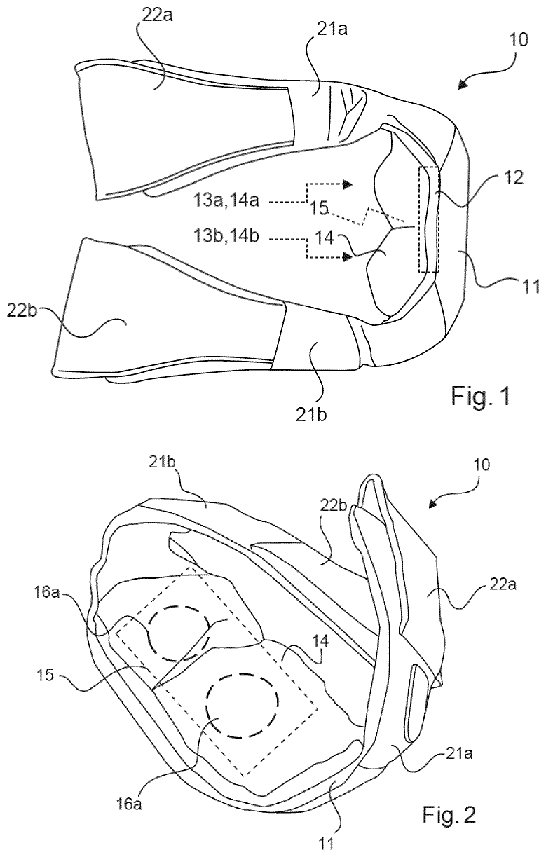

FIG. 1 shows an exemplary embodiment of the massage appliance according to the invention in a schematic illustration;

FIG. 2 shows the massage appliance according to the invention from FIG. 1 in a further schematic illustration; and

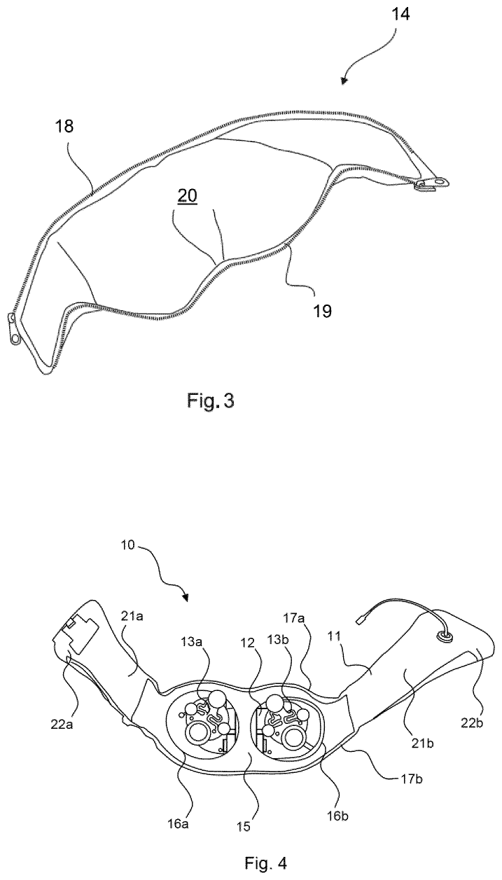

FIG. 3 shows the contact segment of the massage appliance according to the invention from FIG. 1 and FIG. 2 in a schematic illustration; and

FIG. 4 shows the massage appliance according to the invention from FIGS. 1 and 2 in a further schematic illustration.

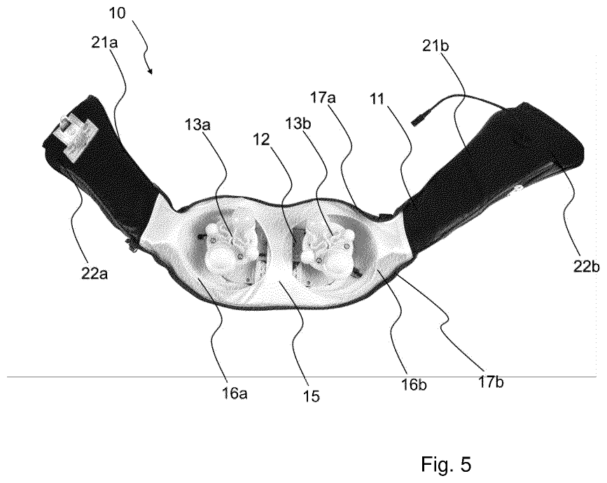

FIG. 5 shows the massage appliance according to the invention from FIG. 4 in an alternative depiction.

According to FIG. 1, FIG. 2 and FIG. 4, the portable massage appliance 10 comprises a main body 11, in which two electrically drivable massage elements 13a, 13b are arranged, and a shape-modifiable contact segment 14. The contact segment 14 is not shown in FIG. 4.

The two electrically drivable massage elements 13a, 13b are designed to cause a modification of the shape of the contact segment 14 during operation. Furthermore, the two electrically drivable massage elements 13a, 13b each have a plurality of massage heads which are moved rotationally in order to perform a kneading massage. The massage elements 13a, 13b extend out of a housing 12 in which an electrically driven massage mechanism is contained. The portable massage appliance 10 also comprises a plurality of heating elements which are arranged inside the main body 11 and are designed to cause heating of the contact segment 14 during operation. A protective segment 15 through which the massage elements (13a, 14b) extend is arranged between the contact segment 14 and the housing 12.

The shape-modifiable contact segment 14 serves for placing onto a body region that is to be massaged. The contact segment 14 has a contact region 20, which is designed to touch the body region that is to be massaged. The contact region 20 is formed from a textile fabric, wherein the textile fabric in turn is formed as a net material. In addition, the contact segment 14 is padded.

The contact segment 14 is connected to the main body 11 so as to be releasable in a non-destructive and reversible manner by means of two zip fasteners 17a, 17b while the protective segment 15 is stitched to the main body 11.

Alternatively or additionally, the contact segment 14 can also be connected to the main body by means of one or more hook-and-loop fasteners and/or by means of one or more press studs.

The main body 11 has two elongate side parts 21a, 21b, which each extend laterally from the contact segment 14. The elongate side parts 21a, 21b of the main body 11 each have a loop 22a, 22b which can be gripped by the user. The main body 11 itself is composed of synthetic leather.

According to FIG. 3, the contact segment 14 has a first row of teeth 18 and a second row of teeth 19. The first row of teeth 18 is part of the zip fastener 17a. The second row of teeth 19 is part of the zip fastener 17b. The first row of teeth 19 runs along a first side edge of the contact segment 14 and the second row of teeth 19 runs along a second side edge of the contact segment 14, the first side edge of the contact segment 14 being arranged substantially opposite the second side edge of the contact segment 14.

### REFERENCE SIGNS

10 Massage appliance
11 Main body
12 Housing
13a, 13b Massage elements
14 Contact segment
15 Protective segment
16a, 16b Openings
17a, 17b Zip fasteners
18, 19 Rows of teeth
10 Contact region of the contact segment (16)
21a, 21b Elongate side parts
22a, 22b Loops

1. A portable massage appliance, having
a shape-modifiable main body,
at least one electrically drivable massage mechanism, which is arranged inside a housing, comprising one or more massage elements at least partially extending out of the housing,
a shape-modifiable contact segment for placing onto a body region that is to be massaged;
wherein the massage elements and the housing are arranged inside the main body, and the massage elements are designed to cause a modification of the shape of the contact segment during operation;
wherein the contact segment is connected to the main body so as to be releasable in a non-destructive and reversible manner,
wherein a protective segment through which the massage elements extend is arranged between the contact segment and the housing.

2. The massage appliance as claimed in claim 1, wherein the protective segment is composed of textile fabric, preferably of net material.

3. The massage appliance as claimed in claim 1, wherein the protective segment has openings through which the massage elements extend.

4. The massage appliance as claimed in claim 3, wherein the number of openings corresponds to the number of massage elements.

5. The massage appliance as claimed in claim 1, wherein the protective segment is irreversibly connected, preferably stitched, to the shape-modifiable main body.

6. The massage appliance as claimed in claim 1, wherein the shape-modifiable main body is at least partially formed from a textile, leather and/or synthetic leather.

7. The massage appliance as claimed in claim 1, wherein the contact segment is connected to the main body by means of one or more zip fasteners.

8. The massage appliance as claimed in claim 7, wherein one or more rows of teeth run along the side edges of the contact segment.

9. The massage appliance as claimed in claim 7, wherein a first row of teeth runs along a first side edge of the contact segment and a second row of teeth runs along a second side edge of the contact segment, the first side edge of the contact segment being arranged substantially opposite the second side edge of the contact segment.

10. The massage appliance as claimed in claim 1, wherein the contact segment is connected to the main body by means of one or more hook-and-loop fasteners.

11. The massage appliance as claimed in claim 1, wherein the contact segment is connected to the main body by means of one or more press studs.

12. The massage appliance as claimed in claim 1, wherein a contact region of the contact segment, which is designed to touch the body region that is to be massaged, is formed at least partially from a textile fabric.

13. The massage appliance as claimed in claim 12, wherein the textile fabric is formed as a net material.

14. The massage appliance as claimed in claim 1, wherein the contact segment is padded at least in some parts.

15. The massage appliance as claimed in claim 1, wherein the main body has two elongate side parts, which each extend laterally from the contact segment.

16. The massage appliance as claimed in claim 15, wherein the elongate side parts of the main body each have a loop.

17. The massage appliance as claimed in claim 1, wherein the one or more electrically drivable massage elements comprise one or more massage heads.

18. The massage appliance as claimed in claim 1, wherein the one or more electrically drivable massage elements are designed to perform a kneading massage or a pummeling massage.

19. The massage appliance as claimed in claim 1, wherein one or more heating elements, which are arranged inside the main body and are designed to cause heating of the contact segment during operation.
